(19) United States
(12) Patent Application Publication
(10) Pub. No.: US 2003/0220862 A1
(43) Pub. Date: Nov. 27, 2003

(54) System and method for managing a web-based agricultural application

(76) Inventors: Benjamin F. Kilgore, Lakeville, MN (US); Rolf S. Peters, St. Paul, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/155,812

(22) Filed: May 24, 2002

(51) Int. Cl. G06F 17/60

(52) U.S. Cl. 705/36

(57) ABSTRACT

A system and method for managing a web-based agricultural application. In one embodiment, a computerized method for managing a commodity-based supply chain includes providing a plurality of participants in the commodity-based supply chain, obtaining commodity-based information from originating process points in the supply chain, obtaining additional commodity-based information from intermediate process points in the supply chain, and selectively providing access to the commodity-based and additional commodity-based information, wherein such providing is traceable through each process point in the supply chain. In another embodiment, wherein the providing of the participants in the commodity-based supply chain further includes providing a plurality of auditors to audit one or more process points in the supply chain. In other embodiments, the obtaining of commodity-based information includes obtaining soft-sell information or obtaining branding information. In these embodiments, the soft-sell information includes information about growers of products, and branding information includes source-specific information about the products.

### FIELD OF THE INVENTION

The present invention relates generally to computer application management, and more particularly to a system and method for managing a web-based agricultural application.

### BACKGROUND INFORMATION

Agricultural goods and commodities are often traded between providers, vendors, and shippers to be processed for the end consumer. In the past, many institutions have been established to allow these types of goods and commodities to be purchased, sold, and distributed in various fashions. These institutions have typically relied on technologies such as telephone communications to transfer information relating to item availability, quality, price, and shipment details. A typical transaction may include sending out hard-copy documentation to customers that lists particular crops or products, proposed prices, and other detailed information. After many rounds of negotiation on the phone, the providers, vendors, shippers, and/or consumers may reach agreement on the logistics for the agricultural loads.

Such a process, however, can become very time consuming, tedious, and inefficient. Because there are a number of parties involved in the transactions, it is often difficult to coordinate discussion and bargaining. It is also difficult to obtain the most updated information concerning item availability, quality, price, and the like. Phone and fax communication can become quite inefficient when trying to coordinate messages and orders from the various parties. Additionally, maintaining and managing hard-copy documentation for many series of transactions provides extra overhead, and may increase the probability of error.

Certain computerized systems provide implementations based on a client-server model to address some of these concerns. These systems, however, do not fully integrate the procurement, logistics, and marketing data management processes to serve the needs of processors, manufacturers, growers, and logistics providers within the agricultural industries. These systems also can often be inefficient, and can lack the capability to trace a product flow from end-to-end.

For the reasons stated above, and for other reasons stated below which will become apparent to those skilled in the art upon reading and understanding the present specification, there is a need for the present invention.

### SUMMARY OF THE INVENTION

One embodiment of the present invention provides a computerized method for managing a commodity-based supply chain. The computerized method includes providing a plurality of participants in the commodity-based supply chain, obtaining commodity-based information from originating process points in the supply chain, obtaining additional commodity-based information from intermediate process points in the supply chain, and selectively providing access to the commodity-based and additional commodity-based information, wherein such providing is traceable through each process point in the supply chain.

Another embodiment of the present invention provides a computerized method for managing a commodity-based supply chain. The computerized method includes providing a plurality of participants in the commodity-based supply chain, wherein the participants include a plurality of users, obtaining commodity-based information from both originating and intermediate process points in the commodity-based supply chain, wherein the commodity-based information has branding information for one or more of the process points, selectively providing access to the commodity-based information by the users that is traceable through each process point in the commodity-based supply chain, and providing a plurality of auditors to certify that the commodity-based information conforms to one or more commodity-based standards.

Another embodiment of the present invention provides a computerized method for providing a total solution for multiple levels of providers and consumers in an agricultural supply chain. The method includes managing multiple purchase contracts with the providers and multiple sale contracts with the consumers for a plurality of products, managing shipping line-ups and logistics to match loads of the products between the providers and the consumers, managing inventories and positions of the products, settling purchases of the products with the providers, managing a plurality of on-line accounts payable systems and a plurality of on-line accounts receivable systems, wherein authorized providers and consumers securely access these accounts payable and accounts receivable systems, tracing end-to-end product transactions using a plurality of unique transaction identifiers, and synchronizing real-time product and payment data with a general ledger platform.

Additional systems and methods are further provided in other various embodiments of the present invention.

### BRIEF DESCRIPTION OF THE DRAWINGS

FIG. 1A illustrates a computerized method for providing a total solution for multiple levels of providers and consumers in an agricultural supply chain, according to one embodiment of the present invention.

FIG. 1B illustrates a computerized method for managing a commodity-based supply chain, according to another embodiment of the present invention.

FIG. 1C illustrates a computerized method for managing a commodity-based supply chain, according to another embodiment of the present invention.

FIG. 1D illustrates end-to-end traceability, according to one embodiment of the present invention.

FIG. 1E illustrates an example of soft-sell information, according to one embodiment of the present invention.

FIG. 2 illustrates a computerized method for real-time management of an enterprise-level agricultural platform by an information broker, according to one embodiment of the present invention.

FIG. 3 illustrates a computerized method for real-time operation of an enterprise agricultural management system by a supplier, according to one embodiment of the present invention.

FIG. 4 illustrates a computerized method for real-time operation of an agricultural management system by a customer, according to one embodiment of the present invention.

FIG. 5 illustrates a computerized system for providing a fully-integrated managed agricultural solution, according to one embodiment of the present invention.

FIG. 6 illustrates a computer screen display for showing contract information, according to one embodiment of the present invention.

FIG. 7 illustrates a computer screen display for showing a set of open contracts, according to one embodiment of the present invention.

FIG. 8 illustrates a computer screen display for managing agricultural loads between a source and a destination, according to one embodiment of the present invention.

FIG. 9 illustrates a computer screen display for lining up shipments between a supplier and a customer, according to one embodiment of the present invention.

FIG. 10 illustrates a computer screen display for managing financial and accounting functionalities, according to one embodiment of the present invention.

FIG. 11 illustrates a computer screen display for displaying a list of operations reports, according to one embodiment of the present invention.

FIG. 12 illustrates a computer screen display for supplier invoice payments, according to one embodiment of the present invention.

FIG. 13 illustrates a computer screen display for displaying open invoice information, according to one embodiment of the present invention.

FIG. 14 illustrates a computer screen display for managing fast-pay operations, according to one embodiment of the present invention.

### DETAILED DESCRIPTION

A novel system and method for managing a web-based agricultural application is described herein. In the following detailed description of the embodiments, reference is made to the accompanying drawings which form a part hereof, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present inventions. The following description is, therefore, not to be taken in a limiting sense.

### Introduction

To address the shortcomings of earlier systems, one embodiment of the present invention provides a secure, web-deployed application that fully integrates the procurement, logistics, and marketing data management processes to serve the needs of processors, manufacturers, growers, and logistics providers within the agricultural industries. This embodiment provides a managed solution that offers significant benefits and cost-savings over traditional client-server applications. Because the application is web-based, there is no need to install software on multiple computers, purchase multiple licenses, have a large (IT) department, or convert back-end systems.

In this embodiment, all authorized users, in one office or many offices, have access to data that they need to perform their specific job functions most productively. Individuals have access to certain general ledger data (e.g. a payables history) without tapping into the entire general ledger system. In addition, remote marketing offices have access to real-time information, such as the current credit status of a particular customer before entering a purchase order.

This embodiment also includes self-reconciling features. For example, when a shipment's scale weight is entered in any location, the system automatically accrues all the payables and receivables associated with that shipment, generates an invoice or settlement ticket, creates a profit estimate by profit center, updates inventory positions, and posts that data to the appropriate reports. The error reduction and labor savings are substantial.

This embodiment, as well as other embodiments of the invention, are further described below.

### Description

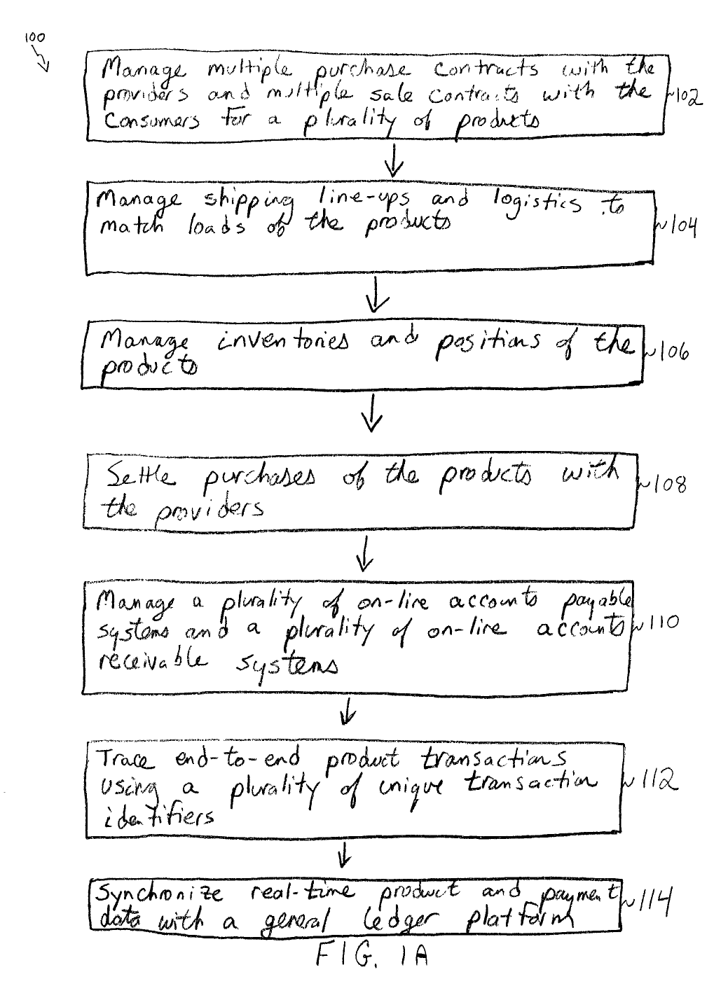

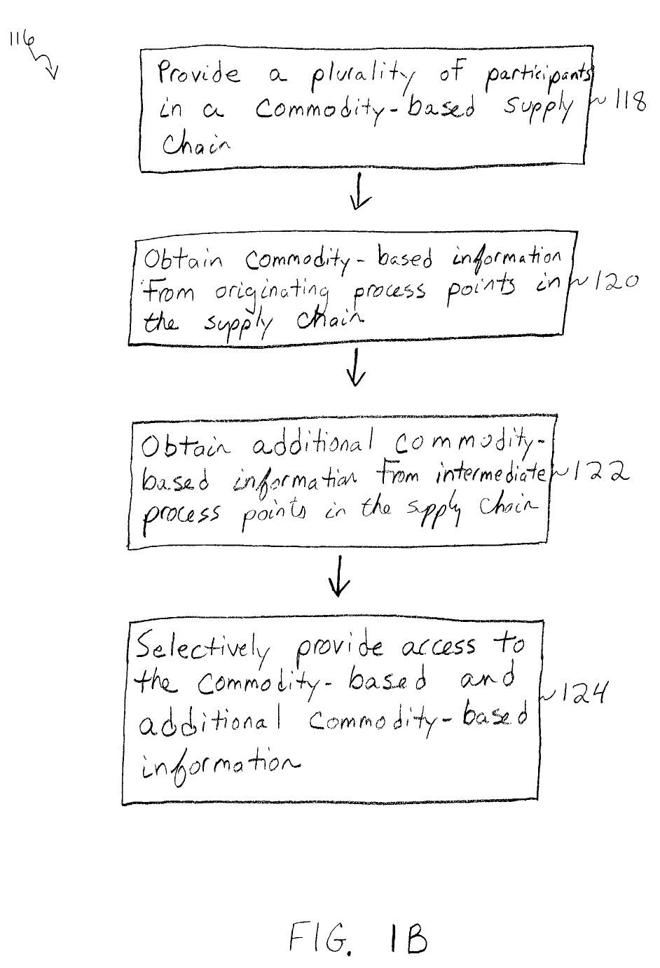

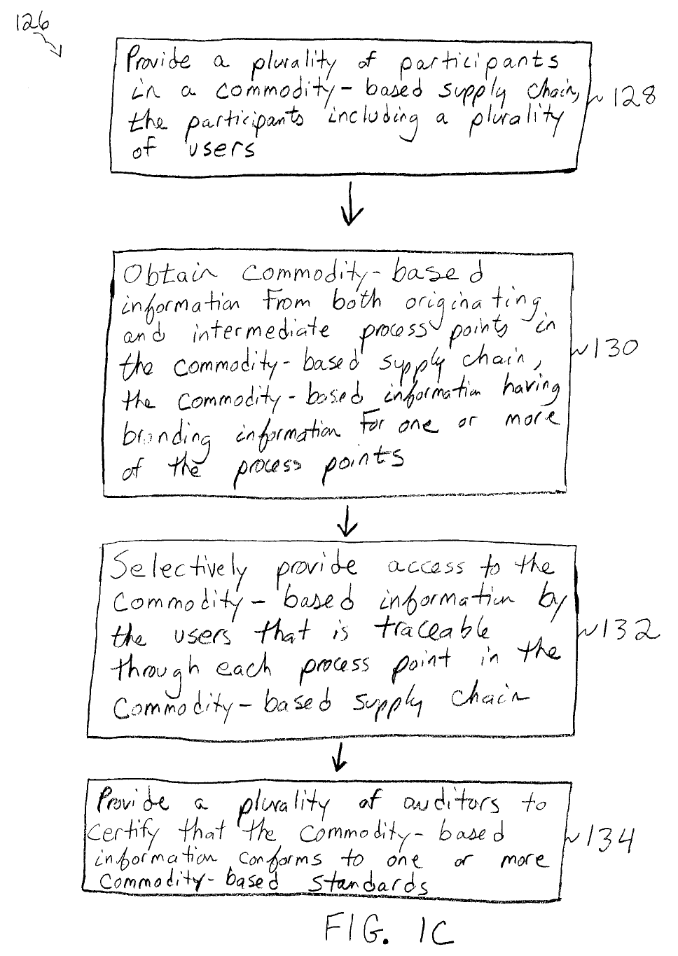

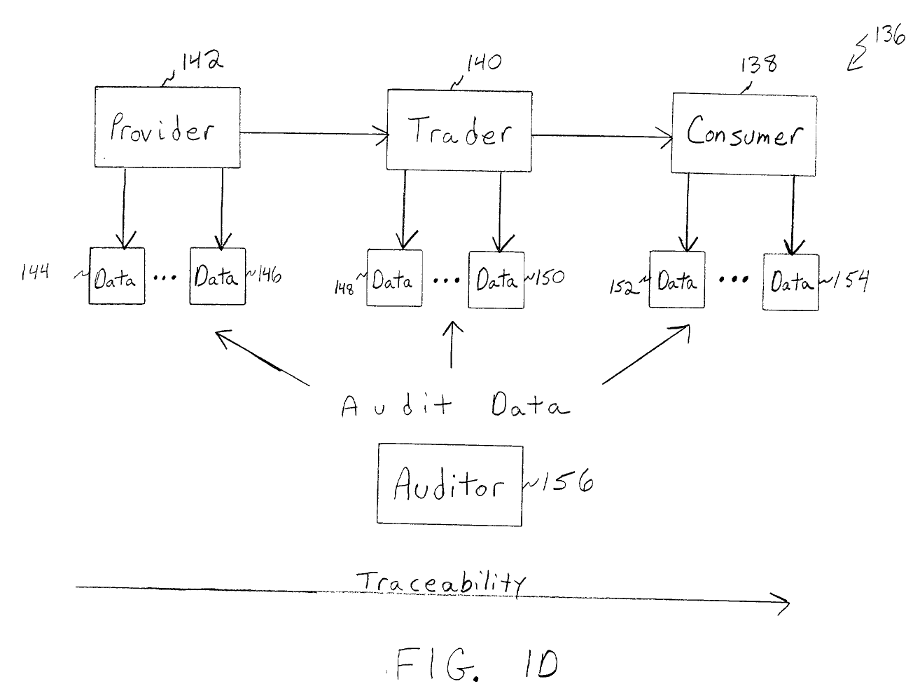

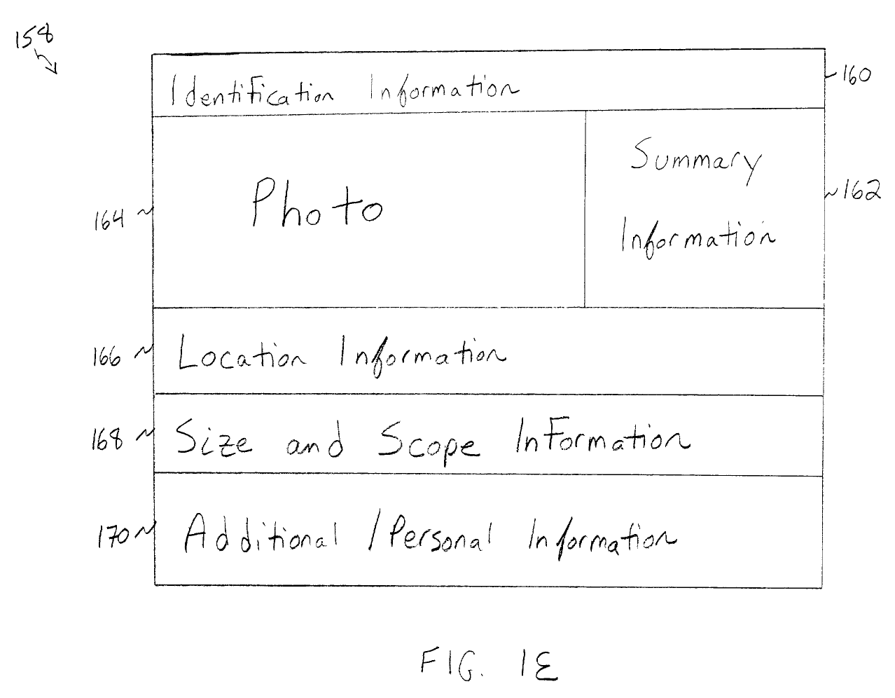

FIG. 1A illustrates a computerized method for providing a total solution for multiple levels of providers and consumers in an agricultural supply chain, according to one embodiment of the present invention. In this embodiment, method 100 includes blocks 102, 104, 106, 108, 110, 112, and 114. Block 102 includes managing multiple purchase contracts with the providers and multiple sale contracts with the consumers for a plurality of products. Block 104 includes managing shipping line-ups and logistics to match loads of the products. Block 106 includes managing inventories and positions of the products. Block 108 includes settling purchases of the products with the providers. Block 110 includes managing a plurality of on-line accounts payable systems and a plurality of on-line accounts receivable systems, wherein authorized providers and consumers securely access these accounts payable and accounts receivable systems. Block 112 includes tracing end-to-end product transactions using a plurality of unique transaction identifiers. Block 114 includes synchronizing real-time product and payment data with a general ledger platform.

In one embodiment, the providers comprise processor, manufacturer, grower, and logistic providers.

In another embodiment, the agricultural supply chain comprises food, grain, and feed industry supply chains.

In another embodiment, the managing of multiple purchase contracts with the providers and multiple sale contracts with the consumers in block 102 includes customizing a user interface, entering contract information by using a personalized contract manager, and automatically adjusting prices for grade discounts or premiums. In this embodiment, a user customizes the user interface to provide a customized “look and feel.” Both purchase and sale contract information may be entered using the personalized contract manager. Users may work on multiple purchase and sale contracts concurrently. This embodiment provides load grading results entry, and contracts may be denominated on a basis or on a flat-priced scheme. Shipping units are denominated in bushels, pounds, tons, or metric tonnes.

In another embodiment, the managing of shipping line-ups and logistics to match loads of the products in block 104 includes matching up loads between providers and consumers. This embodiment provides adding freight carrier and freight rate information, and also supports discounts, premiums, brokerage, transloading, and other special charges.

In another embodiment, the managing of shipping line-ups and logistics to match loads of the products in block 104 includes matching up loads between inventory and plant locations.

In another embodiment, the managing of inventories and positions of the products in block 106 includes managing storage positions by location, product, and delivery month, managing wash sales, and managing carrier movements, wherein the carrier movements include truck-to-rail, rail-to-barge, and truck-to-barge movements.

In another embodiment, the settling of the purchases of the products with the providers in block 108 includes capturing the weight of the products from one or more locations, automatically accruing and posting the payment data to the accounts payable systems upon weight capture, and automatically exporting the payment data in the accounts payable systems into the general ledger platform. This embodiment also provides capturing scale ticket and dockage data from multiple locations.

In another embodiment, the managing of the on-line accounts payable and accounts receivable systems in block 110 includes providing secure access by authorized users to provider-specific information, and providing secure access by authorized users to consumer-specific information. In this embodiment, authorized users are able to view provider-specific payment information, and suppliers access their accounts via secure, on-line connections. This embodiment also provides daily payables file export and automatic posting to the general ledger.

In another embodiment, the synchronizing of real-time product and payment data with the general ledger platform in block 114 includes providing real-time transaction detail with profit estimates or job costing. This embodiment provides automatic and manual exportation and replication of data from the general ledger, and also provides complete management control.

In another embodiment, the synchronizing of real-time product and payment data with the general ledger platform in block 114 includes providing restricted access to general ledger-derived data in a secure environment. This embodiment provides controlled vendor and customer access to back-end information.

In another embodiment, method 100 further includes displaying pending trades, displaying open contracts, displaying active transactions, and displaying transaction histories.

FIG. 1B illustrates a computerized method for managing a commodity-based supply chain, according to another embodiment of the present invention. In this embodiment, method 116 includes blocks 118, 120, 122, and 124. Block 118 includes providing a plurality of participants in the commodity-based supply chain. Block 120 includes obtaining commodity-based information from originating process points in the supply chain. Block 122 includes obtaining additional commodity-based information from intermediate process points in the supply chain. Block 124 includes selectively providing access to the commodity-based and additional commodity-based information, wherein such providing is traceable through each process point in the supply chain.

In one embodiment, method 116 includes managing an agricultural supply chain.

In another embodiment, the providing of the participants in the commodity-based supply chain in block 118 includes providing a plurality of providers, manufacturers, traders, and end-users, wherein the providing of a plurality of providers includes providing a plurality of producers, transporters, and processors.

In another embodiment, the providing of the participants in the commodity-based supply chain in block 118 further includes providing a plurality of auditors to audit one or more process points in the supply chain.

In another embodiment, the obtaining of commodity-based information in blocks 120 and 122 includes obtaining soft-sell information, wherein the obtaining of soft-sell information includes obtaining information about a grower of an agricultural product.

In another embodiment, the obtaining of commodity-based information in blocks 120 and 122 includes obtaining branding information, wherein the obtaining of branding information includes obtaining specific manufacturing information about an agricultural product. In another embodiment, the obtaining of branding information includes obtaining specific source information about an agricultural product.

In another embodiment, the obtaining of commodity-based information in blocks 120 and 122 includes obtaining industry-standard information for the process points in the supply chain.

In another embodiment, the obtaining of commodity-based information in blocks 120 and 122 includes obtaining specific information that has been customized by a participant in the supply chain.

In another embodiment, the obtaining of commodity-based information in blocks 120 and 122 includes obtaining source location information, soil type information, soil map information, or seller information.

In another embodiment, the obtaining of commodity-based information in blocks 120 and 122 includes obtaining contract management information between a provider and an end-user.

In another embodiment, the obtaining of commodity-based information in blocks 120 and 122 includes obtaining scheduled load information, truck carrier information, or lading information, wherein the lading information includes a coupling of source and destination information.

In another embodiment, the selectively providing of access to the commodity-based and additional commodity-based information in block 124 includes selectively displaying the information, wherein the selectively displaying of the information includes displaying the information in different fashions to different participants in the supply chain.

In another embodiment, method 116 further comprises storing the commodity-based and additional commodity-based information in a data store.

FIG. 1C illustrates a computerized method for managing a commodity-based supply chain, according to another embodiment of the present invention. In this embodiment, method 126 includes blocks 128, 130, 132, and 134. Block 128 includes providing a plurality of participants in the commodity-based supply chain, the participants including a plurality of users. Block 130 includes obtaining commodity-based information from both originating and intermediate process points in the commodity-based supply chain, the commodity-based information having branding information for one or more of the process points. Block 132 includes selectively providing access to the commodity-based information by the users that is traceable through each process point in the commodity-based supply chain. Block 134 includes providing a plurality of auditors to certify that the commodity-based information conforms to one or more commodity-based standards.

In one embodiment, the providing of the users in the commodity-based supply chain in block 128 includes providing producers, transporters, and processors.

In another embodiment, the providing of the participants in the commodity-based supply chain in block 128 further includes providing a plurality of manufacturers and consumers.

In another embodiment, the providing of the auditors in block 134 includes providing at least one auditor to certify that the commodity-based information conforms to one or more industry-recognized standards.

In another embodiment, the providing of the auditors in block 134 includes providing at least one auditor to certify that the commodity-based information conforms to one or more user-specific standards.

FIG. 1D illustrates end-to-end traceability, according to one embodiment of the present invention. In this embodiment, system 136 includes provider 142, trader 140, consumer 138, and auditor 156. Provider 142 is a provider of one or more commodity-based products, and is coupled to trader 140. Trader 140 initiates one or more transactions in system 136. Trader 140 is additionally coupled with consumer 138. Consumer 138 is the end-user of the commodity-based products. System 136 illustrates a commodity-based supply chain. Trader 140 can help manage one or more contracts between provider 142 and consumer 138, and facilitate the transactions between the two. Commodity-based data are provided along multiple process points (including originating and intermediate points) in the supply chain, as shown in FIG. 1D. Provider 142 provides commodity-based data (144, 146), such as industry-standard data, soft-sell data, branding data, soil type data, soil map data, and the like. Trader 140 provides commodity-based data (148, 150), such as additional standards data, transactional data (scheduled load, truck carrier, etc.), contract management data, and the like. Consumer 138 provides commodity-based data (152, 154), such as quality information, load information, payment information, and the like. System 136 provides access to the commodity-based data, and such access is traceable (as shown in FIG. 1D) through each process point in the chain. Each of the provider 142, trader 140, and consumer 138 has access to the data, and may access such data in different fashions based on user type and/or permissions granted by system 136. Auditor 156 audits the commodity-based data at various points in the chain, to certify that the data conforms to certain industry or commodity-based standards. Provider 142, trader 140, and/or consumer 138 may also create user-specific standards that are used by auditor 156 when auditing the commodity-based data.

FIG. 1E illustrates an example of soft-sell information, according to one embodiment of the present invention. In this example embodiment, soft-sell information 158 is representative of the type of data that can be provided by a provider in an agricultural supply-chain system. Soft-sell information 158 includes identification information 160, photo 164, summary information 162, location information 166, size and scope information 168, and additional/personal information 170. Identification information 160 includes unique or specific information that identifies the provider, or the provider's location. Summary information 162 includes any information that summarizes details about the provider, or details about the soft-sell data in general. Photo 164 includes one or more pictures, or photographs, of the providers (or their product/location). Location information 166 includes details about the provider's location. Size and scope information 168 includes information about the size of the provider's location, and the scope of the products produced (such as product types, product amounts, and the like). Additional/personal information 170 includes any additional or personal information, such as historical or resume information, association membership information, hobby information, and the like.

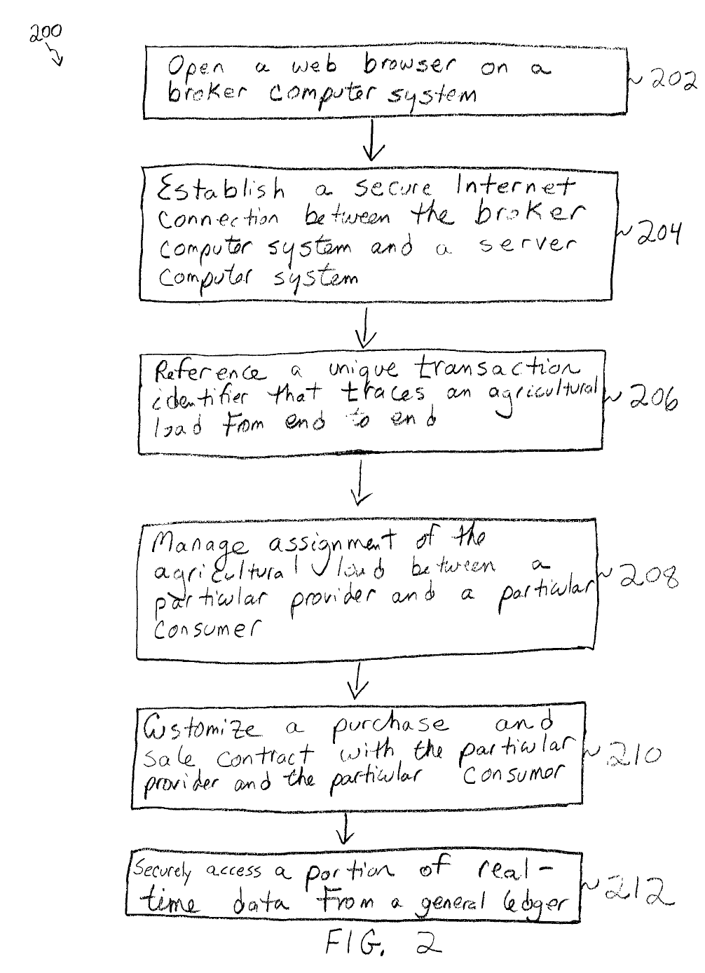

FIG. 2 illustrates a computerized method for real-time management of an enterprise-level agricultural platform by an information broker, according to one embodiment of the present invention. In this embodiment, method 200 includes blocks 202, 204, 206, 208, 210, and 212. Block 202 includes opening a web browser on a broker computer system. Block 204 includes establishing a secure Internet connection between the broker computer system and a server computer system. Block 206 includes referencing a unique transaction identifier that traces an agricultural load from end to end. Block 208 includes managing assignment of the agricultural load between a particular provider and a particular consumer. Block 210 includes customizing a purchase and sale contract with the particular provider and the particular consumer. Block 212 includes securely accessing a portion of real-time data from a general ledger.

In one embodiment, method 200 further includes managing one or more inventory bins to track inventory accounting of an additional agricultural load.

In another embodiment, method 200 further includes conducting an opportunity search to identify the particular consumer according to specific trade interests.

In another embodiment, method 200 further includes conducting a carrier search to identify a carrier for the agricultural load according to one or more criteria.

In another embodiment, method 200 further includes managing a fast-pay service. In this embodiment, users may instantly pay for one or more transactional loads via a selectable on-line screen.

In another embodiment, the accessing of the portion of real-time data from the general ledger in block 212 includes accessing consumer account information, accessing provider account information, and accessing completed transaction information.

In another embodiment, the accessing of the portion of real-time data from the general ledger in block 212 includes accessing special report information, the special report information including company lookup report data, open transactions report data, pending provider invoice report data, open provider invoice report data, closed provider invoice report data, shipments out of contract report data, profit and loss by broker report data, residual account detail report data, accounting export report data, accounts receivable-aging report data, position report data, provider invoice payment data, records sent to accounting report data, and premiums and discounts report data.

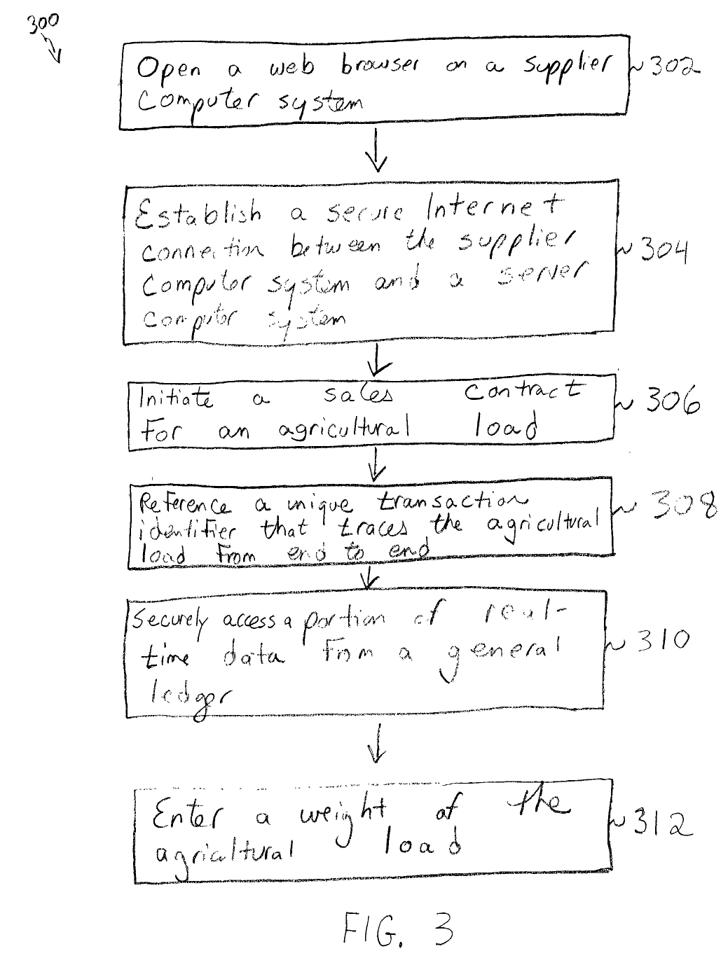

FIG. 3 illustrates a computerized method for real-time operation of an enterprise agricultural management system by a supplier, according to one embodiment of the present invention. In this embodiment, method 300 includes blocks 302, 304, 306, 308, 310, and 312. Block 302 includes opening a web browser on a supplier computer system. Block 304 includes establishing a secure Internet connection between the supplier computer system and a server computer system. Block 306 includes initiating a sales contract for an agricultural load. Block 308 includes referencing a unique transaction identifier that traces the agricultural load from end to end. Block 310 includes securely accessing a portion of real-time data from a general ledger. Block 312 includes entering a weight of the agricultural load. In this embodiment, the server computer system automatically exports all payable and receivables data associated with the unique transaction identifier into the general ledger upon the entering of the weight.

In one embodiment, the initiating of the sales contract for the agricultural load in block 306 includes customizing a user interface, and entering sales contract information by using a personalized sales contract manager.

In another embodiment, the accessing of the portion of real-time data from the general ledger in block 310 includes accessing supplier account information, and accessing completed transaction information.

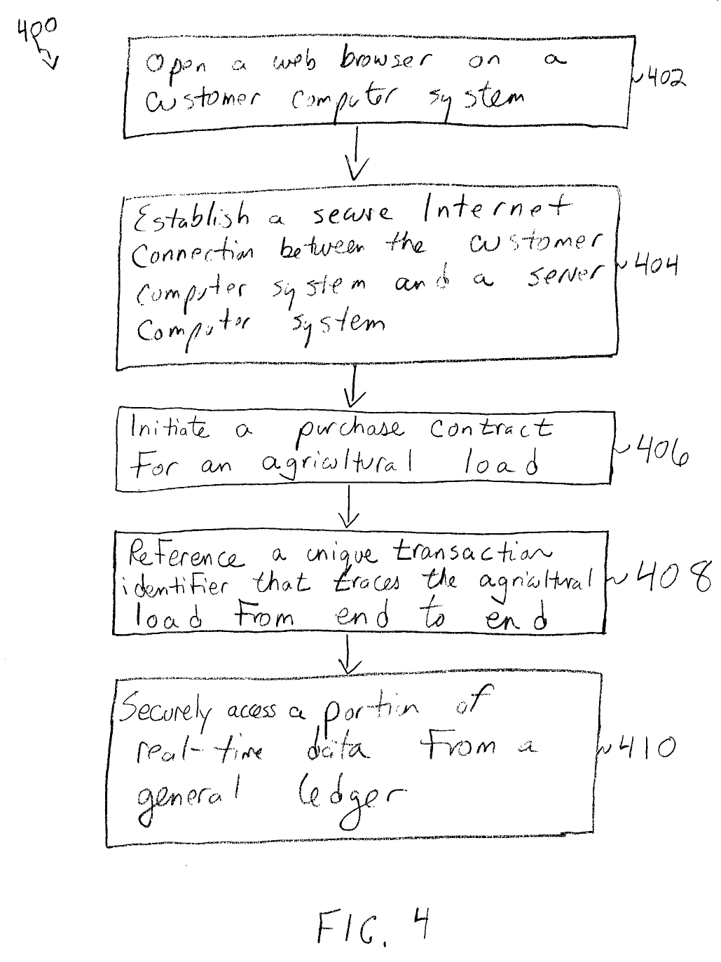

FIG. 4 illustrates a computerized method for real-time operation of an agricultural management system by a customer, according to one embodiment of the present invention. In this embodiment, method 400 includes blocks 402, 404, 406, 408, and 410. Block 402 includes opening a web browser on a customer computer system. Block 404 includes establishing a secure Internet connection between the customer computer system and a server computer system. Block 406 includes initiating a purchase contract for an agricultural load. Block 408 includes referencing a unique transaction identifier that traces the agricultural load from end to end. Block 410 includes securely accessing a portion of real-time data from a general ledger.

In one embodiment, the initiating of the purchase contract for the agricultural load in block 406 includes customizing a user interface, and entering purchase contract information by using a personalized purchase contract manager.

In another embodiment, the accessing of the portion of real-time data from the general ledger in block 410 includes accessing customer account information, and accessing completed transaction information.

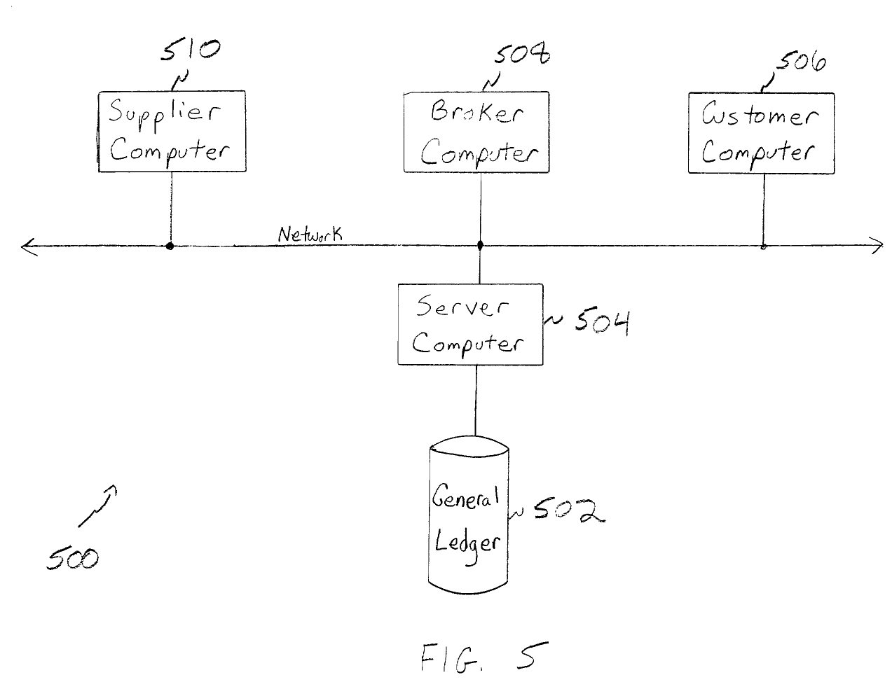

FIG. 5 illustrates a computerized system for providing a fully-integrated managed agricultural solution, according to one embodiment of the present invention. System 500 includes a network, server computer 504 that is coupled to the network, supplier computer 510 that is securely coupled to server computer 504 through the network, customer computer 506 that is securely coupled to server computer 504 through the network, broker computer 508 that is securely coupled to server computer 504 through the network, and system software. In this particular embodiment, system 500 also includes general ledger 502 that is coupled to server computer 504. The system software is executed by system 500 to create a unique transaction identifier that traces an agricultural load from end to end, manage assignment of the agricultural load between a particular vendor and a particular customer, customize a purchase and sale contract with the particular vendor and the particular customer, manage one or more inventory bins to track inventory accounting of the agricultural load, entering a weight of the agricultural load, automatically export all payables and receivables data associated with the unique transaction identifier into a general ledger upon the entering of the weight, and securely access a portion of real-time data from the general ledger.

In one embodiment, the network comprises an Internet network. In this embodiment, customer computer 506, broker computer 508, and supplier computer 510 are each coupled to server computer 504 via a secure Internet network connection. Customer computer 506, broker computer 508, and supplier computer 510 each provide a web browser to allow users to access server computer 504.

In another embodiment, the system software is further executed by system 500 to send payment to the particular vendor upon verification of receipt of the agricultural load.

In a different embodiment, a computerized system for managing a commodity-based supply chain includes a network, a server computer coupled to the network, one or more client computers coupled to the server computer via the network, and system software. The system software is operable on the computerized system to obtain commodity-based information from both initial and intermediate process points in a commodity-based supply chain, and selectively provide access to the commodity-based information that is traceable through each process point in the commodity-based supply chain, wherein the commodity-based information includes both branding information and client-customized information for one or more process points in the supply chain. In one embodiment, the system software is further operable on the computerized system to obtain branding information that includes specific manufacturing information about an agricultural product. In another embodiment, the system software is further operable on the computerized system to obtain branding information that includes specific source information about an agricultural product.

In a different embodiment, a computerized system for managing a commodity-based supply chain includes a network, a server computer coupled to the network, one or more user computers coupled to the server computer via the network, and system software. The system software is operable on the computerized system to obtain commodity-based information from both originating and intermediate process points in the commodity-based supply chain, wherein the commodity-based information includes branding information for one or more of the process points, selectively provide access to the commodity-based information by the user computers, wherein the information is traceable through each process point in the commodity-based supply chain, and provide a plurality of auditors to certify that the commodity-based information conforms to one or more commodity-based standards. In one embodiment, the system software is further operable on the computerized system to provide at least one auditor to certify that the commodity-based information conforms to one or more industry-recognized standards. In another embodiment, the system software is further operable on the computerized system to provide at least one auditor to certify that the commodity-based information conforms to one or more user-specific standards.

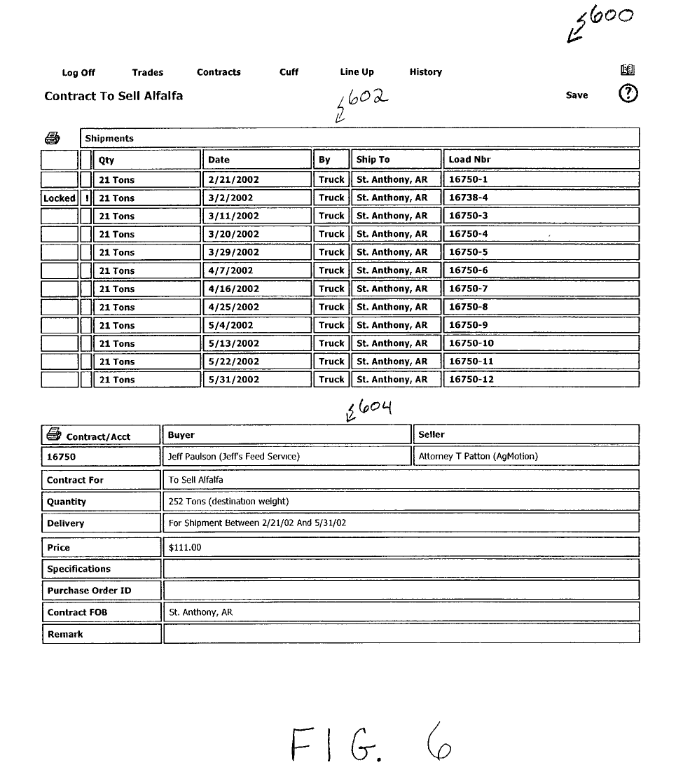

FIG. 6 illustrates a computer screen display for showing contract information, according to one embodiment of the present invention. In this embodiment, screen display 600 includes shipment information 602 and contract information 604 for contracts to sell alfalfa. Shipment information 602 includes quantity information (in tons), date information (of the shipments), carrier information (i.e. by truck), destination information, and load number information. Each shipment has a particular load number. Shipment information 602 shows that there are a number of shipments for alfalfa. Contract information 604 includes specific contract and account information for specific load numbers. Contract information 604 shows both the buyer and seller information for the contract to sell alfalfa. Contract information 604 also shows quantity, delivery, and price information, as well as remarks that can be entered by a user. Screen display 600 allows a user to manage contracts between buyers and sellers.

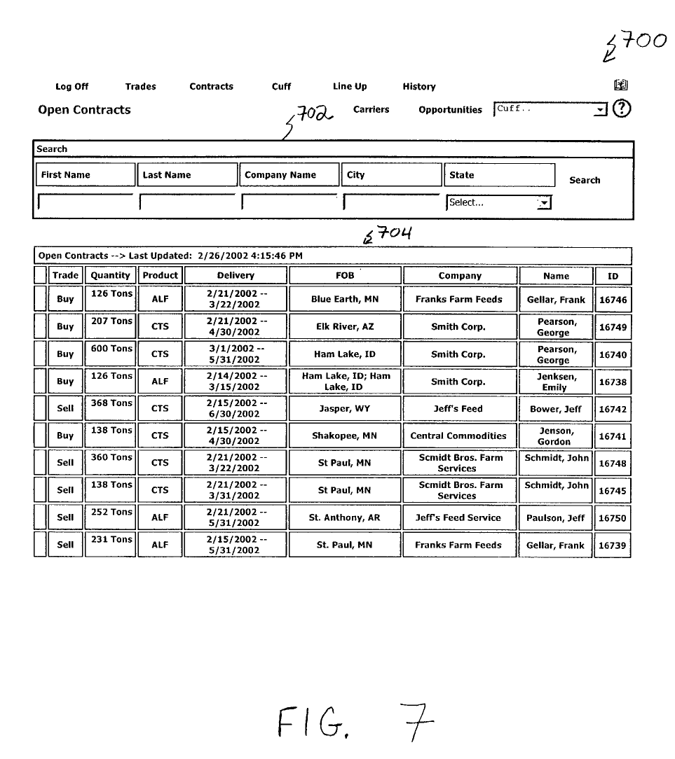

FIG. 7 illustrates a computer screen display for showing a set of open contracts, according to one embodiment of the present invention. In this embodiment, screen display 700 includes search field 702 and open contract information 704. Search field 702 includes various entry fields that allow a user to search for individuals and companies in various cities and states. Open contract information 704 includes trade information, quantity information, product information, delivery information, Free-On-Board (FOB) information, company information, name information, and identification (ID) information. Open contract information 704 shows information about open contracts in the system, for various products, and in various quantities. One can trace an individual contract transaction using the ID shown.

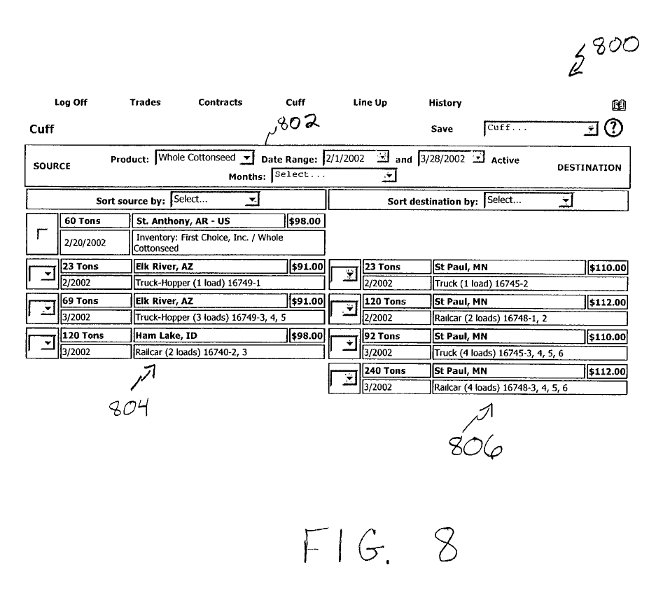

FIG. 8 illustrates a computer screen display for managing agricultural loads between a source and a destination, according to one embodiment of the present invention. In this embodiment, screen display 800 includes selection field 802, source information 804, and destination information 806. Selection field 802 includes a product selector, and various date selectors. A user may select a particular product, and may specify specific date ranges. Source information 804 shows information pertaining to the sources of the agricultural loads. Source information 804 includes quantity information, location information, carrier information, and price information. Destination information 806 shows information pertaining to the destinations of the agricultural loads. Destination information 806 includes quantity information, location information, carrier information, and price information. By using the highlight and selection features of screen display 800, a user is able to manage and assign agricultural loads between a source and a destination.

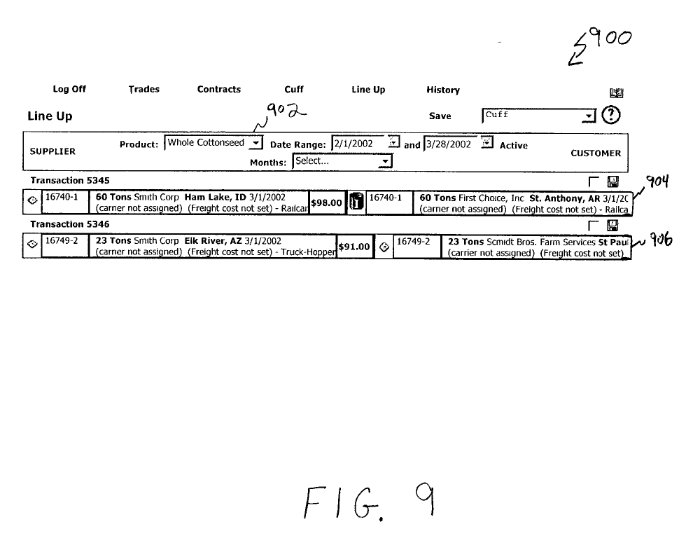

FIG. 9 illustrates a computer screen display for lining up shipments between a supplier and a customer, according to one embodiment of the present invention. In this embodiment, screen display 900 includes selection field 902, transaction field 904, and transaction field 906. Selection field 902 includes a product selector, and various date selectors. A user may select a particular product, and may specify specific date ranges. Transaction fields 904 and 906 include unique transaction identifiers, and transaction information. The transaction information includes quantity information, supplier information, customer information, carrier information (including freight carrier and freight rate information), and price information. Screen display 900 allows a user to line up shipments between a supplier and a customer.

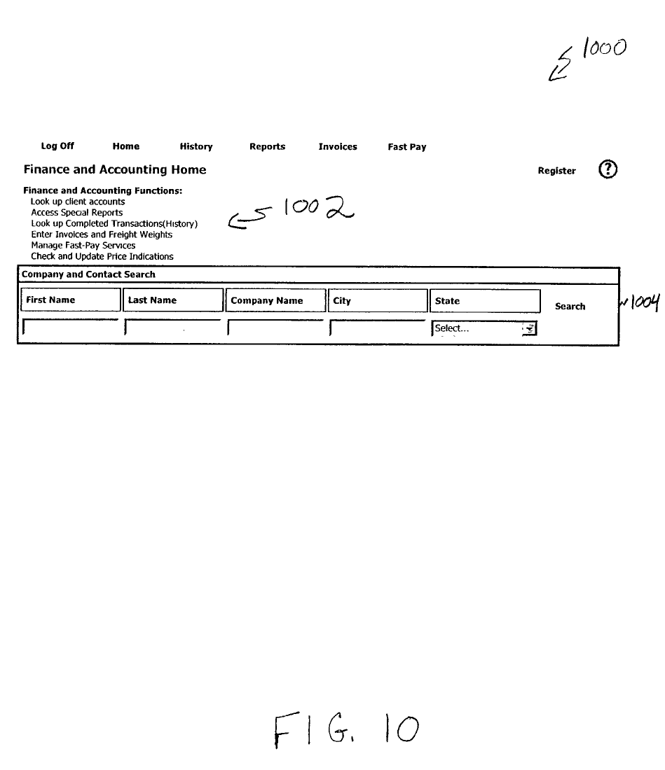

FIG. 10 illustrates a computer screen display for managing financial and accounting functionalities, according to one embodiment of the present invention. In this embodiment, screen display 1000 includes function set 1002 and search field 1004. Search field 1004 includes various entry fields that allow a user to search for individuals and companies in various cities and states. Function set 1002 includes various financial and accounting functionalities that can be managed. Function set 1002 includes functions for looking up client accounts, accessing special reports, looking up completed transactions (history), entering invoices and freight weights, managing fast-pay services, and checking/updating price indications. In one embodiment, a user may select any one of the functions included in function set 1002 with a pointing device to utilize the given function. Authorized users are able to view vendor-specific payment information. Suppliers are able to access their accounts via secure, on-line access. Other authorized users are able to view customer-specific accounts payable and payment information. In another embodiment, function set 1002 provides an on-line accounts payable and accounts receivable management system.

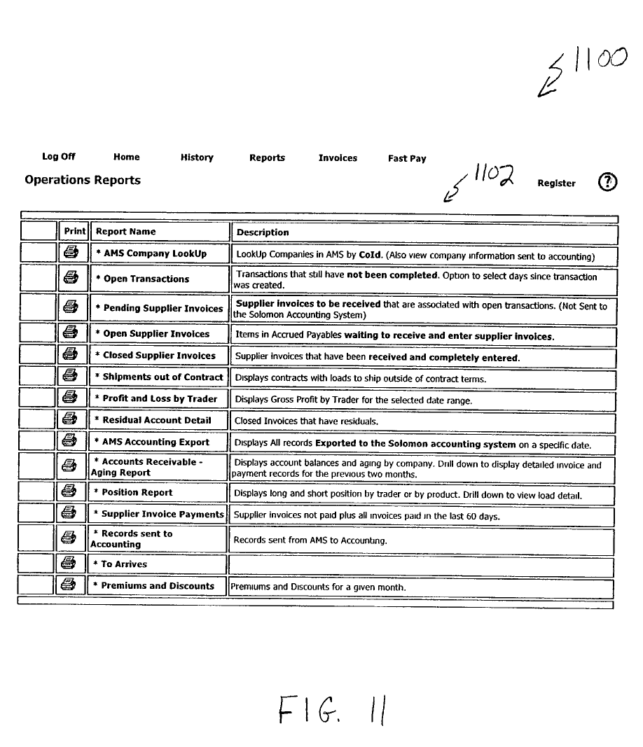

FIG. 11 illustrates a computer screen display for displaying a list of operations reports, according to one embodiment of the present invention. In this embodiment, screen display 1102 includes operations report list 1102. Operations report list 1102 include various reports that may be selected by a user. In one embodiment, the user selects any one of the reports in operations report list 1102 with a pointing device to display the given report. Operations report list 1102 includes reports for company lookup, open transactions, pending supplier invoices, open supplier invoices, closed supplier invoices, shipments out of contract, profit and loss by trader, residual account details, accounting export, accounts receivable-aging, positions, supplier invoice payments, records sent to accounting, and premiums and discounts.

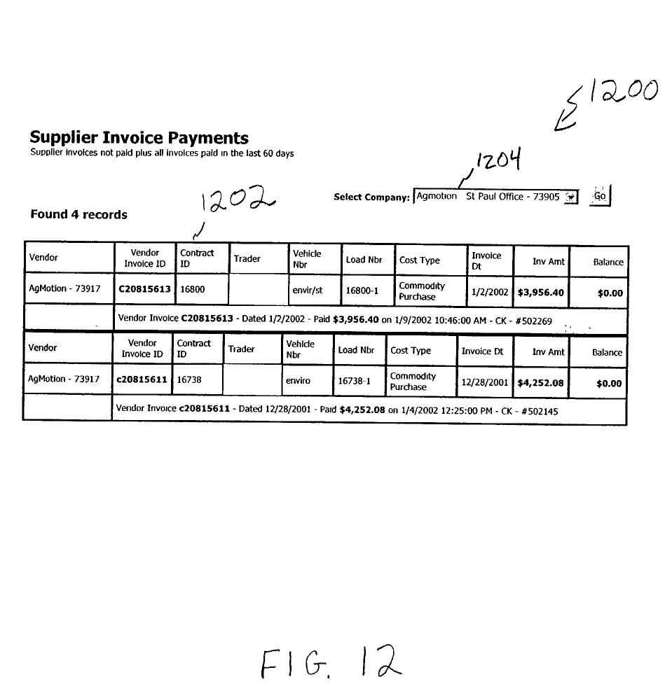

FIG. 12 illustrates a computer screen display for supplier invoice payments, according to one embodiment of the present invention. In this embodiment, screen display 1200 includes invoice information 1202. Invoice information 1202 shows supplier invoices not paid plus all invoices paid in the last 60 days. Selection field 1204 allows a user to select a specific company for which to display invoice information. Invoice information 1202 includes vendor information, invoice and contract identifier information, vehicle and load number information, date information, and cost information. Screen display 1200 allows a user to quickly and easily view supplier invoice information.

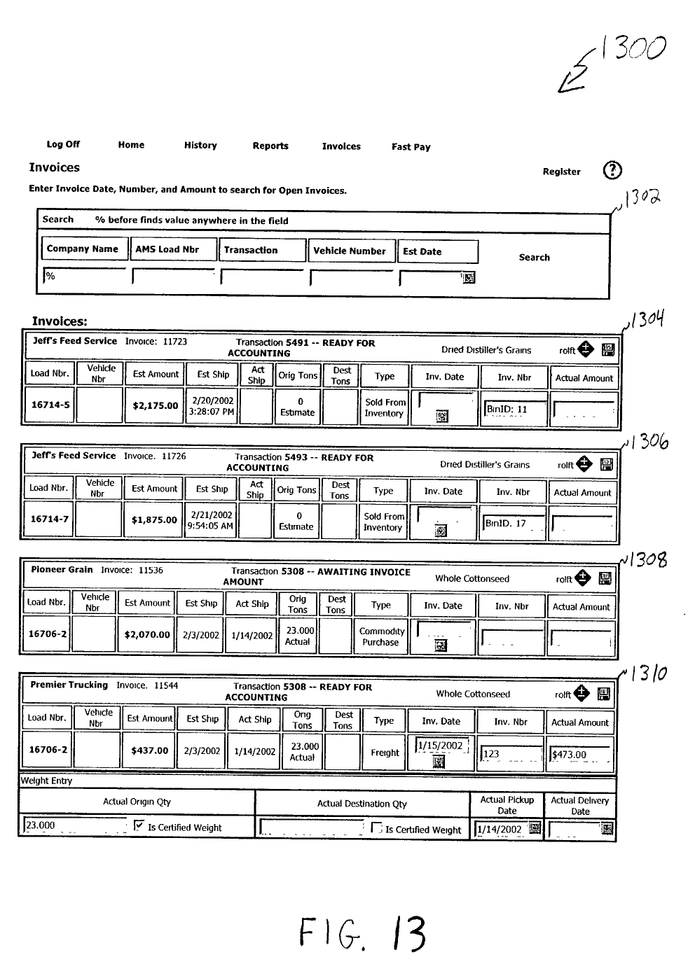

FIG. 13 illustrates a computer screen display for displaying open invoice information, according to one embodiment of the present invention. In this embodiment, screen display 1300 includes search field 1302, invoice information 1304, invoice information 1306, invoice information 1308, and invoice information 1310. Search field 1302 provides open invoice search capabilities based on company name, load number, transaction, vehicle number, and date. Each of the invoice information fields 1304, 1306, 1308, and 1310 provide information regarding open invoices in the system. For example, invoice information 1310 includes company information, product information, transaction identifier information, load and vehicle number information, price information, shipping information, date information, carrier information, delivery information, and weight information. Screen display 1300 allows a user to view open invoices in the system for various companies and products, and to assess routing and delivery information.

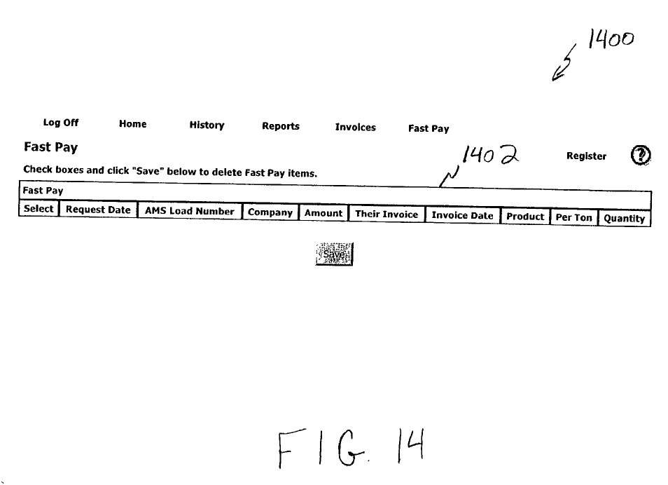

FIG. 14 illustrates a computer screen display for managing fast-pay operations, according to one embodiment of the present invention. In this embodiment, screen display 1400 includes fast pay field 1402. Fast pay field 1402 provides one or more items that can be selected for the fast pay functionality. Each item includes a pay request date, load number, payable company, amount, invoice information, product information, weight information, and quantity information. Screen display 1400 allows a user to select and manage fast pay operations for one or more agricultural loads or transactions. In one embodiment, the fast pay operation is an electronic transfer pay operation.

Various embodiments of the present invention (as described above) provide effective and efficient ways to implement the stated functionalities. In these embodiments, the graphical user-interface provides unique capabilities and “look-and-feel” to provide functionality. This includes requiring reduced user input into the system (such as, for example, fewer keystrokes or input device movements), so that users are able to obtain results quickly and easily.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A computerized method for managing a commodity-based supply chain, the computerized method comprising:
providing a plurality of participants in the commodity-based supply chain;
obtaining commodity-based information from originating process points in the supply chain;
obtaining additional commodity-based information from intermediate process points in the supply chain; and
selectively providing access to the commodity-based and additional commodity-based information, wherein such providing is traceable through each process point in the supply chain.

2. The computerized method of claim 1, wherein the computerized method includes managing an agricultural supply chain.

3. The computerized method of claim 1, wherein the providing of the participants in the commodity-based supply chain includes providing a plurality of providers, manufacturers, traders, and end-users.

4. The computerized method of claim 3, wherein the providing of a plurality of providers includes providing a plurality of producers, transporters, and processors.

5. The computerized method of claim 1, wherein the providing of the participants in the commodity-based supply chain further includes providing a plurality of auditors to audit one or more process points in the supply chain.

6. The computerized method of claim 1, wherein the obtaining of commodity-based information includes obtaining soft-sell information.

7. The computerized method of claim 6, wherein the obtaining of soft-sell information includes obtaining information about a grower of an agricultural product.

8. The computerized method of claim 1, wherein the obtaining of commodity-based information includes obtaining branding information.

9. The computerized method of claim 8, wherein the obtaining of branding information includes obtaining specific manufacturing information about an agricultural product.

10. The computerized method of claim 8, wherein the obtaining of branding information includes obtaining specific source information about an agricultural product.

11. The computerized method of claim 1, wherein the obtaining of commodity-based information includes obtaining industry-standard information for the process points in the supply chain.

12. The computerized method of claim 1, wherein the obtaining of commodity-based information includes obtaining specific information that has been customized by a participant in the supply chain.

13. The computerized method of claim 1, wherein the obtaining of commodity-based information includes obtaining source location information, soil type information, soil map information, or seller information.

14. The computerized method of claim 1, wherein the obtaining of commodity-based information includes obtaining contract management information between a provider and an end-user.

15. The computerized method of claim 1, wherein the obtaining of commodity-based information includes obtaining scheduled load information, truck carrier information, or lading information, wherein the lading information includes a coupling of source and destination information.

16. The computerized method of claim 1, wherein the selectively providing of access to the commodity-based and additional commodity-based information includes selectively displaying the information.

17. The computerized method of claim 16, wherein the selectively displaying of the information includes displaying the information in different fashions to different participants in the supply chain.

18. The computerized method of claim 1, wherein the computerized method further comprises storing the commodity-based and additional commodity-based information in a data store.

19. A computerized system for managing a commodity-based supply chain, the computerized system comprising:
a network;
a server computer coupled to the network;
one or more client computers coupled to the server computer via the network; and
system software operable on the computerized system to
obtain commodity-based information from both initial and intermediate process points in a commodity-based supply chain, and
selectively provide access to the commodity-based information that is traceable through each process point in the commodity-based supply chain,
wherein the commodity-based information includes both branding information and client-customized information for one or more process points in the supply chain.

20. The computerized system of claim 19, wherein the system software is further operable on the computerized system to obtain branding information that includes specific manufacturing information about an agricultural product.

21. The computerized system of claim 19, wherein the system software is further operable on the computerized system to obtain branding information that includes specific source information about an agricultural product.

22. A computerized method for managing a commodity-based supply chain, the computerized method comprising:
providing a plurality of participants in the commodity-based supply chain, the participants including a plurality of users;
obtaining commodity-based information from both originating and intermediate process points in the commodity-based supply chain, the commodity-based information having branding information for one or more of the process points;
selectively providing access to the commodity-based information by the users that is traceable through each process point in the commodity-based supply chain; and
providing a plurality of auditors to certify that the commodity-based information conforms to one or more commodity-based standards.

23. The computerized method of claim 22, wherein the providing of the users in the commodity-based supply chain includes providing producers, transporters, and processors.

24. The computerized method of claim 22, wherein the providing of the participants in the commodity-based supply chain further includes providing a plurality of manufacturers and consumers.

25. The computerized method of claim 22, wherein the providing of the auditors includes providing at least one auditor to certify that the commodity-based information conforms to one or more industry-recognized standards.

26. The computerized method of claim 22, wherein the providing of the auditors includes providing at least one auditor to certify that the commodity-based information conforms to one or more user-specific standards.

27. A computerized system for managing a commodity-based supply chain, the computerized system comprising:
a network;
a server computer coupled to the network;
one or more user computers coupled to the server computer via the network; and
system software operable on the computerized system to
obtain commodity-based information from both originating and intermediate process points in the commodity-based supply chain, wherein the commodity-based information includes branding information for one or more of the process points,
selectively provide access to the commodity-based information by the user computers, wherein the information is traceable through each process point in the commodity-based supply chain, and
provide a plurality of auditors to certify that the commodity-based information conforms to one or more commodity-based standards.

28. The computerized system of claim 27, wherein the system software is further operable on the computerized system to provide at least one auditor to certify that the commodity-based information conforms to one or more industry-recognized standards.

29. The computerized system of claim 27, wherein the system software is further operable on the computerized system to provide at least one auditor to certify that the commodity-based information conforms to one or more user-specific standards.

30. A computerized method for providing a total solution for multiple levels of providers and consumers in an agricultural supply chain, the method comprising:
managing multiple purchase contracts with the providers and multiple sale contracts with the consumers for a plurality of products;
managing shipping line-ups and logistics to match loads of the products;
managing inventories and positions of the products;
settling purchases of the products with the providers;
managing a plurality of on-line accounts payable systems and a plurality of on-line accounts receivable systems, wherein authorized providers and consumers securely access these accounts payable and accounts receivable systems;
tracing end-to-end product transactions using a plurality of unique transaction identifiers; and
synchronizing real-time product and payment data with a general ledger platform.

31. The computerized method of claim 30, wherein the providers comprise processor, manufacturer, grower, and logistic providers.

32. The computerized method of claim 30, wherein the agricultural supply chain comprises food, grain, and feed industry supply chains.

33. The computerized method of claim 30, wherein the managing of multiple purchase contracts with the providers and multiple sale contracts with the consumers comprises:
customizing a user interface;
entering contract information by using a personalized contract manager; and
automatically adjusting prices for grade discounts or premiums.

34. The computerized method of claim 30, wherein the managing of shipping line-ups and logistics to match loads of the products includes matching up loads between providers and consumers.

35. The computerized method of claim 30, wherein the managing of shipping line-ups and logistics to match loads of the products includes matching up loads between inventory and plant locations.

36. The computerized method of claim 30, wherein the managing of inventories and positions of the products comprises:
managing storage positions by location, product, and delivery month;
managing wash sales; and
managing carrier movements, wherein the carrier movements include truck-to-rail, rail-to-barge, and truck-to-barge movements.

37. The computerized method of claim 30, wherein the settling of the purchases of the products with the providers comprises:
capturing the weight of the products from one or more locations;
automatically accruing and posting the payment data to the accounts payable systems upon weight capture; and
automatically exporting the payment data in the accounts payable systems into the general ledger platform.

38. The computerized method of claim 30, wherein the managing of the on-line accounts payable and accounts receivable systems comprises:
providing secure access by authorized users to provider-specific information; and
providing secure access by authorized users to consumer-specific information.

39. The computerized method of claim 30, wherein the synchronizing of real-time product and payment data with the general ledger platform includes providing real-time transaction detail with profit estimates or job costing.

40. The computerized method of claim 30, wherein the synchronizing of real-time product and payment data with the general ledger platform includes providing restricted access to general ledger-derived data in a secure environment.

41. The computerized method of claim 30, further comprising:
displaying pending trades;
displaying open contracts;
displaying active transactions; and
displaying transaction histories.

42. A computerized method for real-time management of an enterprise-level agricultural platform by an information broker, the method comprising:
opening a web browser on a broker computer system;
establishing a secure Internet connection between the broker computer system and a server computer system;
referencing a unique transaction identifier that traces an agricultural load from end to end;
managing assignment of the agricultural load between a particular provider and a particular consumer;
customizing a purchase and sale contract with the particular provider and the particular consumer; and
securely accessing a portion of real-time data from a general ledger.

43. The computerized method of claim 42, further comprising managing one or more inventory bins to track inventory accounting of an additional agricultural load.

44. The computerized method of claim 42, further comprising conducting an opportunity search to identify the particular consumer according to specific trade interests.

45. The computerized method of claim 42, further comprising conducting a carrier search to identify a carrier for the agricultural load according to one or more criteria.

46. The computerized method of claim 42, further comprising managing a fast-pay service.

47. The computerized method of claim 42, wherein the securely accessing of the portion of real-time data from the general ledger comprises:
securely accessing consumer account information;
securely accessing provider account information; and
securely accessing completed transaction information.

48. The computerized method of claim 42, wherein the securely accessing of the portion of real-time data from the general ledger comprises securely accessing special report information, the special report information including company lookup report data, open transactions report data, pending provider invoice report data, open provider invoice report data, closed provider invoice report data, shipments out of contract report data, profit and loss by broker report data, residual account detail report data, accounting export report data, accounts receivable-aging report data, position report data, provider invoice payment data, records sent to accounting report data, and premiums and discounts report data.

49. A computerized method for real-time operation of an enterprise agricultural management system by a supplier, the method comprising:
opening a web browser on a supplier computer system;
establishing a secure Internet connection between the supplier computer system and a server computer system;
initiating a sales contract for an agricultural load;
referencing a unique transaction identifier that traces the agricultural load from end to end;
securely accessing a portion of real-time data from a general ledger; and
entering a weight of the agricultural load,
wherein the server computer system automatically exports all payable and receivables data associated with the unique transaction identifier into the general ledger upon the entering of the weight.

50. The computerized method of claim 49, wherein the initiating of the sales contract for the agricultural load comprises:
customizing a user interface; and
entering sales contract information by using a personalized sales contract manager.

51. The computerized method of claim 49, wherein the securely accessing of the portion of real-time data from the general ledger comprises:
securely accessing supplier account information; and
securely accessing completed transaction information.

52. A computerized method for real-time operation of an agricultural management system by a customer, the method comprising:
opening a web browser on a customer computer system;
establishing a secure Internet connection between the customer computer system and a server computer system;
initiating a purchase contract for an agricultural load;
referencing a unique transaction identifier that traces the agricultural load from end to end; and
securely accessing a portion of real-time data from a general ledger.

53. The computerized method of claim 52, wherein the initiating of the purchase contract for the agricultural load comprises:
customizing a user interface; and
entering purchase contract information by using a personalized purchase contract manager.

54. The computerized method of claim 52, wherein the securely accessing of the portion of real-time data from the general ledger comprises:
securely accessing customer account information; and
securely accessing completed transaction information.

55. A computerized system for providing a fully-integrated managed agricultural solution, the system comprising:
a network;
a server computer coupled to the network;
a supplier computer securely coupled to the server computer through the network;
a customer computer securely coupled to the server computer through the network;
a broker computer securely coupled to the server computer through the network; and
system software that is executed by the computerized system to
create a unique transaction identifier that traces an agricultural load from end to end,
manage assignment of the agricultural load between a particular vendor and a particular customer,
customize a purchase and sale contract with the particular vendor and the particular customer,
manage one or more inventory bins to track inventory accounting of the agricultural load,
enter a weight of the agricultural load,
automatically export all payables and receivables data associated with the unique transaction identifier into a general ledger upon the entering of the weight, and
securely access a portion of real-time data from the general ledger.

56. The computerized system of claim 55, wherein the system software is further executed by the computerized system to send payment to the particular vendor upon verification of receipt of the agricultural load.

57. The computerized system of claim 55, wherein the network comprises an Internet network.
